(19) United States
(12) Patent Application Publication
(10) Pub. No.: US 2014/0205771 A1
(43) Pub. Date: Jul. 24, 2014

(54) Bezel Sealant, Liquid Crystal Display Panel and Liquid Crystal Display

(71) Applicants: Hong-Ji Huang, Shenzhen City (CN); Xinhui Zhong, Shenzhen City (CN); Chihhsien Li, Shenzhen City (CN)

(72) Inventors: Hong-Ji Huang, Shenzhen City (CN); Xinhui Zhong, Shenzhen City (CN); Chihhsien Li, Shenzhen City (CN)

(73) Assignee: Shenzhen China Star Optoelectronics Technology Co. Ltd., Shenzhen, Guangdong (CN)

(21) Appl. No.: 13/824,401

(22) PCT Filed: Jan. 31, 2013
(86) PCT No.: PCT/CN13/71206

§ 371 Date: Mar. 18, 2013

(30) Foreign Application Priority Data
Jan. 23, 2013 (CN) 201310024704.8

(51) Int. Cl. C09D 163/00; C09D 133/06

(52) U.S. Cl. CPC C09D 163/00; C09D 133/06
USPC 428/1.52; 522/83; 522/81; 522/82; 522/71

(57) ABSTRACT

The present invention provides a bezel sealant for use in a polymer stabilized vertical alignment liquid crystal display. The bezel sealant includes at least the following compositions: epoxy resin 20-60% by weight, curing agent 5-50% by weight, methacrylate resin or acrylate resin 20-60% by weight, photoinitiator 0.1-1% by weight, filler 5-35% by weight, and silane coupling agent 0.05-5% by weight. The molecular weight of the methacrylate resin or the acrylate resin is greater than or equal to 500. According to the embodiment of the present invention, the dissolution of the methacrylate resin or acrylate resin in the bezel sealant by the liquid crystal medium is prevented to avoid the over-sized bumps formed in the periphery of the bezel. Light leakage phenomenon in the periphery of the bezel is decreased to increase product yield rate.

### CROSS-REFERENCE TO RELATED APPLICATION

This application claims priority from and the benefit under 35 U.S.C. §119(a) of Chinese Patent Application No. 201310024704.8, filed on Jan. 23, 2013, which is hereby incorporated by reference for all purposes as if fully set forth herein.

### BACKGROUND OF THE INVENTION

1. Field of the Invention

The present invention relates to a liquid crystal display technology, more particularly, to a bezel sealant, a liquid crystal display panel and a liquid crystal display.

2. Description of the Related Art

In a twisted nematic (TN) or a super twisted nematic (STN) liquid crystal display, since positive liquid crystal molecules are utilized, the long axes of the liquid crystal molecules lie parallel to the surface of the substrate when no voltage is applied. The alignment direction of the liquid crystal molecules on the surface of the substrate is determined by the rubbing direction of the alignment layer (usually made of Polyimide), and the alignment directions of the surfaces of the two substrates are perpendicular to each other. Hence, the liquid crystal molecules will twist continuously from the surface of one substrate to the surface of the other substrate. When a voltage is applied, the long axes of the liquid crystal molecules will tend to align along the direction of the electric field. The drawback is that the TN/STN liquid crystal display has a small view angle. When viewed from a large angle, the brightness difference and chromatic aberration are serious. Under the circumstances, compensation films are utilized to make improvement but the manufacturing cost of the display is inevitably increased.

Multi-domain vertical alignment (MVA) thin film transistor liquid crystal display (TFT-LCD) well solves the problem of limited view angle for the TN/STN liquid crystal display. The MVA TFT-LCD uses negative liquid crystal molecules and alignment layers having a perpendicular alignment direction. When no voltage is applied, the long axes of the liquid crystal molecules are all perpendicular to the surface of the substrate. The liquid crystal molecules will tilt after voltage is applied so that the long axes of the liquid crystal molecules tend to align perpendicular to the direction of the electric field. In order to solve the view angle problem, one sub pixel is divided into a plurality of domains to allow the liquid crystal molecules align along different directions. The display effects of the display viewed from different directions are thus consistent. That the liquid crystal molecules in different domains of one sub pixel align along different directions can be achieved in many ways. The first is to form bumps on the upper and lower substrates of the LCD by utilizing exposure and development process to provide the liquid crystal molecules surrounding the bumps with a specific pre-tilt angle. As a result, the liquid crystal molecules will tilt along a fixed direction. The second is to form Indium Tin Oxide (ITO) pixel electrodes having a predetermined pattern on the upper and lower substrates. Hence, an electric field having a specific tilt angle is generated to control the orientations of the liquid crystal molecules in different domains. This technology is called patterned vertical alignment (PVA). The third is to form ITO slits on the side of the LCD substrate having the TFTs and form full ITO on the opposite side, and add polymerizable monomers in the liquid crystal medium. An electric field is first applied to tilt the liquid crystal molecules. Then the panel is irradiated with ultraviolet light to polymerize the monomers. Consequently, polymer particles that would render the liquid crystal molecules tilt are deposited on the surfaces of the substrates to align the liquid crystal molecules. Such a technology is called polymer stabilized vertical alignment (PSVA).

In PSVA technology, the process for forming polymer bumps is a phase separation process. Before polymerization, monomer is a small molecule and has a good compatibility with liquid crystal medium. During the manufacturing process it is necessary to irradiate the panel with ultraviolet light so that polymerization reaction occurs when the monomers are irradiated with the ultraviolet light. The polymers then separate from the liquid crystal medium once they are formed and become polymer particles not dissolved in the liquid crystal medium. They are thus the polymer bumps being able to align the liquid crystal molecules.

However, the bezel sealants now adopted are mostly cured by a hybrid process. Namely, they comprise methacrylate monomers need to be cured with ultraviolet light and epoxy resins need to be cured with heat. Therefore, ultraviolet light irradiation is first performed to polymerize the methacrylate resin so that cross-linking curing reaction occurs. Then a high-temperature curing is performed to cross-link the epoxy resins, which is another portion of the sealants. By doing this, the binding force between the bezel sealant and the glass substrates is improved to tightly join the two glass substrates. The overflow of liquid crystal is prevented. At the same time, moisture and oxygen in the air are prevented from entering into the inside of the liquid crystal cell.

Since the methacrylate monomer in the bezel sealant has a very similar structure to the polymerizable monomer in the liquid crystal medium, it's possible that part of the methacrylate monomers in the bezel sealant are dissolved by the liquid crystal medium during the manufacturing process of the panel and participates in the polymerization reaction when irradiated with ultraviolet light. Therefore, larger bumps are often formed in the periphery region of the panel close to the bezel sealant to cause bright spots in dark state. As a result, light leakage occurs in the periphery of the PSVA panel. It is easy to understand that the bezel sealant utilized in the PSVA technology needs to be further improved.

### SUMMARY OF THE INVENTION

The present invention provides a bezel sealant, a liquid crystal display panel and a liquid crystal display, capable of preventing the dissolution of methacrylate resin or acrylate resin in the bezel sealant by the liquid crystal medium and preventing their participation in the polymerization reaction. The formation of over-sized bumps is avoided to decrease light leakage phenomenon in the periphery of the bezel.

The present invention provides a bezel sealant for use in a polymer stabilized vertical alignment liquid crystal display. The bezel sealant comprises at least the following compositions:

epoxy resin 20-60% by weight;

curing agent 5-50% by weight;

methacrylate resin or acrylate resin 20-60% by weight;

photoinitiator 0.1-1% by weight

filler 5-35% by weight; and

silane coupling agent 0.05-5% by weight;
wherein the molecular weight of the methacrylate resin or the acrylate resin is greater than or equal to 500.

In one aspect of the present invention, the epoxy resin comprises an aromatic epoxy resin or/and a non-aromatic epoxy resin.

In another aspect of the present invention, the epoxy resin comprises a bisphenol-A epoxy resin, a bisphenol-F epoxy resin, a bisphenol-S epoxy resin, a novolac-type epoxy resin, a biphenyl epoxy resin, an epoxy resin having a cyclohexene oxide structure, and an epoxy resin having a cyclopentene oxide structure.

In another aspect of the present invention, the curing agent is at least one selected from the group consisting of a multi-amine curing agent and an anhydride-type curing agent.

In still another aspect of the present invention, the filler is selected from the following inorganic fillers: silicon dioxide, aluminum oxide, zinc oxide, titanium oxide, magnesium oxide, calcium sulfate, aluminum nitride, and silicon nitride.

In yet another aspect of the present invention, the silane coupling agent is at least one selected from the following materials:

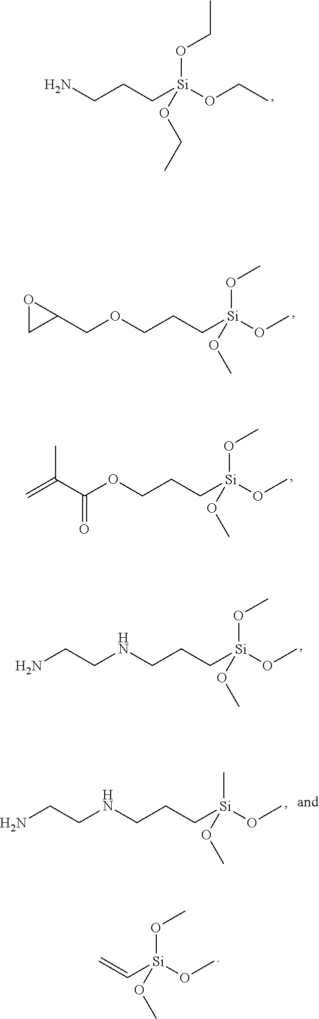

The present invention also provides a polymer stabilized vertical alignment liquid crystal display panel. The liquid crystal display panel comprises a first substrate, a second substrate, a liquid crystal layer disposed between the first substrate and the second substrate, and a bezel sealant for sealing liquid crystal molecules between the two substrates. The liquid crystal layer comprises at least polymerizable monomers, and a molecular weight of the polymerizable monomer is smaller than 500. The bezel sealant comprises at least the following compositions:

epoxy resin 20-60% by weight;

curing agent 5-50% by weight;

methacrylate resin or acrylate resin 20-60% by weight;

photoinitiator 0.1-1% by weight

filler 5-35% by weight; and

silane coupling agent 0.05-5% by weight;
wherein the molecular weight of the methacrylate resin or the acrylate resin is greater than or equal to 500.

In one aspect of the present invention, the epoxy resin comprises an aromatic epoxy resin or/and a non-aromatic epoxy resin.

In another aspect of the present invention, the epoxy resin comprises a bisphenol-A epoxy resin, a bisphenol-F epoxy resin, a bisphenol-S epoxy resin, a novolac-type epoxy resin, a biphenyl epoxy resin, an epoxy resin having a cyclohexene oxide structure, and an epoxy resin having a cyclopentene oxide structure.

In another aspect of the present invention, the curing agent is at least one selected from the group consisting of a multi-amine curing agent and an anhydride-type curing agent.

In still another aspect of the present invention, the filler is selected from the following inorganic fillers: silicon dioxide, aluminum oxide, zinc oxide, titanium oxide, magnesium oxide, calcium sulfate, aluminum nitride, and silicon nitride.

In yet another aspect of the present invention, the silane coupling agent is at least one selected from the following materials:

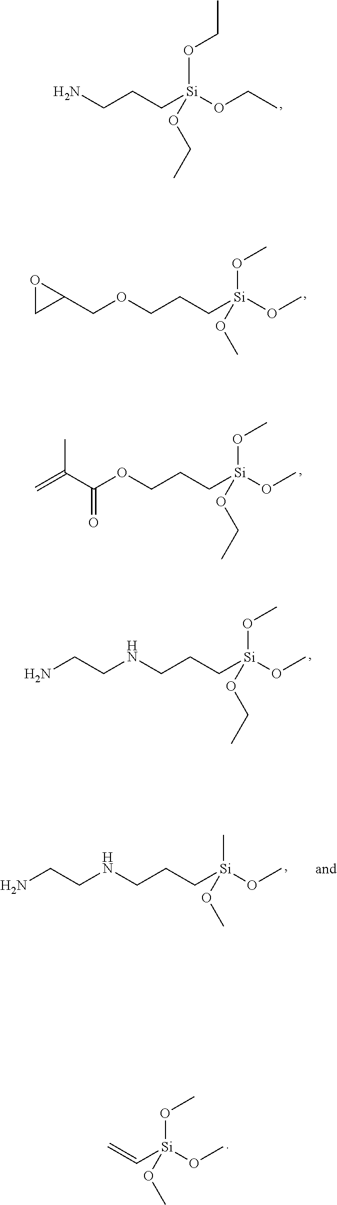

The present invention further provides a polymer stabilized vertical alignment liquid crystal display device. The polymer stabilized vertical alignment liquid crystal display device comprises a liquid crystal display panel. The liquid crystal display panel comprises a first substrate, a second substrate, a liquid crystal layer disposed between the first substrate and the second substrate, and a bezel sealant for sealing liquid crystal molecules between the two substrates. The liquid crystal layer comprises at least polymerizable monomers, and a molecular weight of the polymerizable monomer is smaller than 500. The bezel sealant comprises at least the following compositions:

epoxy resin 20-60% by weight;

curing agent 5-50% by weight;

methacrylate resin or acrylate resin 20-60% by weight;

photoinitiator 0.1-1% by weight

filler 5-35% by weight; and

silane coupling agent 0.05-5% by weight;
wherein the molecular weight of the methacrylate resin or the acrylate resin is greater than or equal to 500.

In one aspect of the present invention, the epoxy resin comprises an aromatic epoxy resin or/and a non-aromatic epoxy resin.

In another aspect of the present invention, the epoxy resin comprises a bisphenol-A epoxy resin, a bisphenol-F epoxy resin, a bisphenol-S epoxy resin, a novolac-type epoxy resin, a biphenyl epoxy resin, an epoxy resin having a cyclohexene oxide structure, and an epoxy resin having a cyclopentene oxide structure.

In another aspect of the present invention, the curing agent is at least one selected from the group consisting of a multi-amine curing agent and an anhydride-type curing agent.

In still another aspect of the present invention, the filler is selected from the following inorganic fillers: silicon dioxide, aluminum oxide, zinc oxide, titanium oxide, magnesium oxide, calcium sulfate, aluminum nitride, and silicon nitride.

In yet another aspect of the present invention, the silane coupling agent is at least one selected from the following materials:

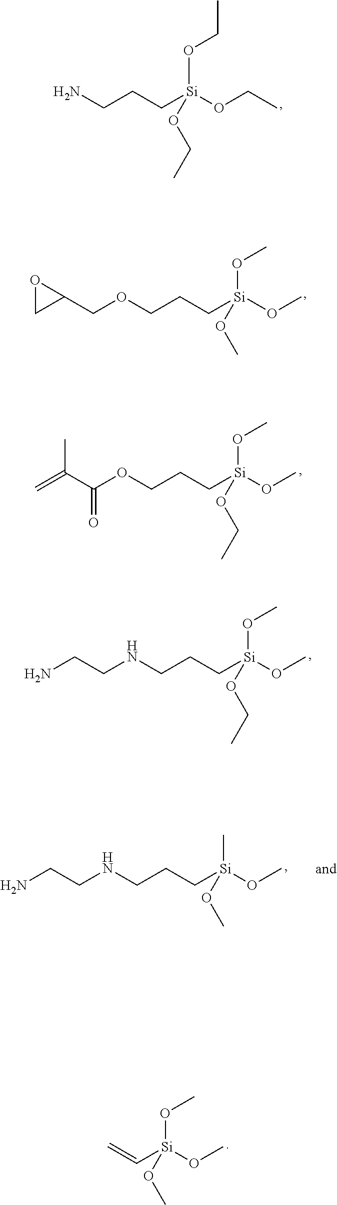

In contrast to the prior art, the methacrylate resin or acrylate resin utilized in the bezel sealant has a molecular weight greater than 500 according to the embodiment of the present invention. Since the molecular weight of the methacrylate resin or acrylate resin in the bezel sealant is much greater than that of the polymerizable monomers utilized in the liquid crystal medium, it is obviously different from the polymerizable monomers in the liquid crystal medium. Hence, the dissolution of the methacrylate resin or acrylate resin in the bezel sealant by the liquid crystal medium is prevented to avoid the over-sized bumps formed in the periphery of the bezel. As a result, light leakage phenomenon in the periphery of the bezel is decreased.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a PSVA liquid crystal display panel according to the present invention.

### DESCRIPTION OF THE EMBODIMENTS

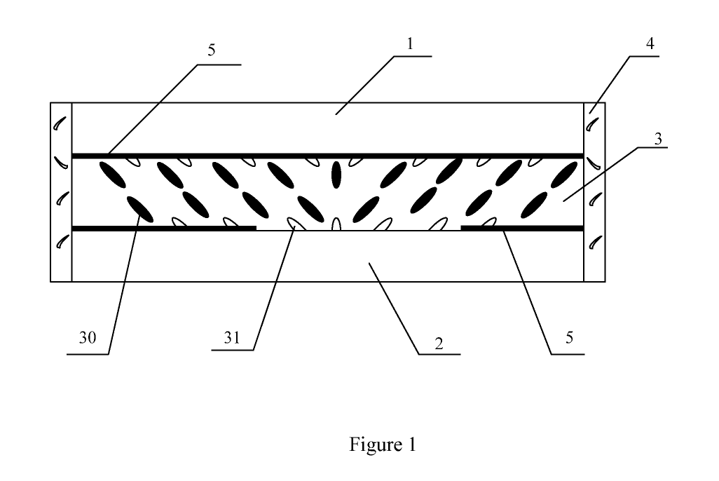

Please refer to FIG. 1, FIG. 1 is a schematic diagram of a PSVA liquid crystal display panel according to the present invention. The liquid crystal display panel comprises a first substrate 1, a second substrate 2, a liquid crystal layer 3 disposed between the two substrates, and a bezel sealant 4 for sealing liquid crystal molecules between the two substrates. There are ITO electrodes 5 disposed on a side of the first substrate 1 and a side of the second substrate 2 opposite to the side of the first substrate 1. The liquid crystal layer 3 comprises at least liquid crystal molecules 30 and polymerizable monomers. When voltage is applied on the ITO electrodes 5, the polymerizable monomers will form bumps 31 on the first substrate 1 and the second substrate 2. The molecular weight of the polymerizable monomer in the liquid crystal layer 3 is smaller than 500.

The bezel sealant 4 comprises at least the following compositions:

epoxy resin 20-60% by weight;

curing agent 5-50% by weight;

methacrylate resin or acrylate resin need to be cured by ultraviolet light is 20-60% by weight. The molecular weight of the methacrylate resin or acrylate resin is greater than or equal to 500;

photoinitiator 0.1-1% by weight

filler 5-35% by weight; and

silane coupling agent.

The epoxy resin is 20-60% by weight of the total bezel sealant material. The epoxy resin material may be composed of one kind of epoxy resin or a plurality of epoxy resins having different structures. The selected structure may be represented by the following general structures. The material can be selected from, but not limited to the following material: an aromatic epoxy resin comprising a bisphenol-A epoxy resin, a bisphenol-F epoxy resin, a bisphenol-S epoxy resin, a novolac-type epoxy resin (such as a phenol novolac-type epoxy resin, a cresol novolac-type epoxy resin), and a biphenyl epoxy resin. The molecular structure of the aromatic epoxy resin comprises one or more than one epoxy group. The epoxy equivalent of the resin can be properly selected. A non-aromatic epoxy resin is the epoxy resin whose molecular structure does not comprise any aromatic ring, and the epoxy group in it usually has a deformed ring, such as the epoxy resin having a cyclohexene oxide structure or a cyclopentene oxide structure.

The curing agent is a curing agent for epoxy resins. It is 5-50% by weight of the total bezel sealant material. It may be composed of one compound or a plurality of compounds. The compound is preferably at least one selected from the group consisting of a multi-amine curing agent and a anhydride-type curing agent.

The methacrylate resin and acrylate resin are organic resin materials comprising a methacrylate group and an acrylate group, respectively. The organic resin material may be composed of one kind or two different kinds of resins, and its average molecular weight is greater than 500. In addition, it is 20-60% by weight of the total bezel sealant material.

The photoinitiator is 0.1-1% by weight of the total bezel sealant material. The photoinitiator is an ultraviolet-sensitive substance that is able to absorb ultraviolet light having a wavelength smaller than 380 nm and initiate polymerization reaction. For example: the IRGACURE 1173 and the IRGACURE 651 photoinitiators from Ciba. The photoinitiator may be composed of one kind or a plurality kind of photoinitiators.

The filler is 5-35% by weight of the total bezel sealant material. The filler is selected from, but not limited to the following inorganic fillers, for example, silicon dioxide, aluminum oxide, zinc oxide, titanium oxide, magnesium oxide, calcium sulfate, aluminum nitride, and silicon nitride.

The silane coupling agent is 0.05-5% by weight of the total bezel sealant material. The silane coupling agent is selected from, but not limited to the following materials:

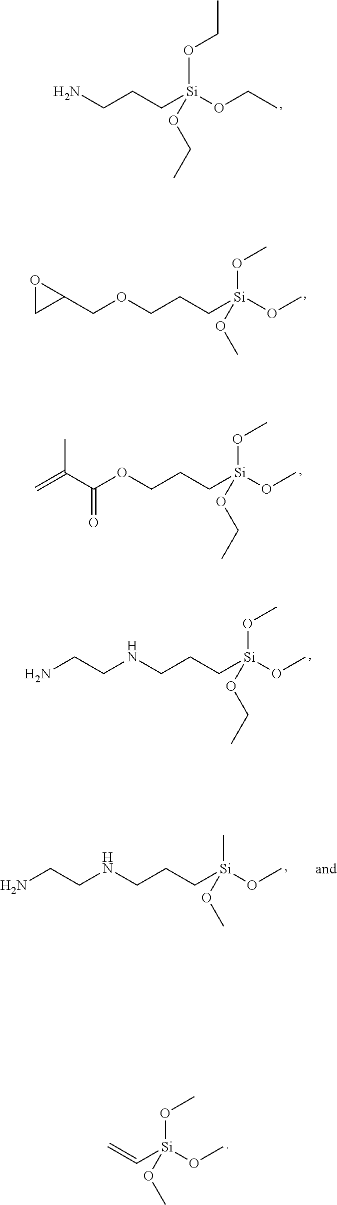

Correspondingly, a PSVA liquid crystal display is provided according to the embodiment of the present invention. The PSVA liquid crystal display comprises the liquid crystal display panel as described in FIG. 1.

Generally speaking, the solubility of the same substance in a medium will decrease as its molecular weight increases. According to the embodiment of the present invention, the methacrylate resin or acrylate resin having a greater molecular weight is utilized as the resin in the bezel sealant needs to be cured with ultraviolet light, it is obviously different from the polymerizable monomers in the liquid crystal medium. Hence, the dissolution of the methacrylate resin or acrylate resin in the bezel sealant by the liquid crystal medium is prevented to avoid the over-sized bumps formed in the periphery of the bezel. As a result, light leakage phenomenon in the periphery of the bezel is decreased to increase yield rate of liquid crystal panels.

Those skilled in the art will readily observe that numerous modifications and alterations of the device and method may be made while retaining the teachings of the invention. Accordingly, the above disclosure should be construed as limited only by the metes and bounds of the appended claims.

1. A bezel sealant for use in a polymer stabilized vertical alignment liquid crystal display, the bezel sealant comprising at least the following compositions:
epoxy resin 20-60% by weight;
curing agent 5-50% by weight;
methacrylate resin or acrylate resin 20-60% by weight;
photoinitiator 0.1-1% by weight filler 5-35% by weight; and
silane coupling agent 0.05-5% by weight;
wherein the molecular weight of the methacrylate resin or the acrylate resin is greater than or equal to 500.

2. The bezel sealant as claimed in claim 1, wherein the epoxy resin comprises an aromatic epoxy resin or/and a non-aromatic epoxy resin.

3. The bezel sealant as claimed in claim 2, wherein the epoxy resin comprises a bisphenol-A epoxy resin, a bisphenol-F epoxy resin, a bisphenol-S epoxy resin, a novolac-type epoxy resin, a biphenyl epoxy resin, an epoxy resin having a cyclohexene oxide structure, and an epoxy resin having a cyclopentene oxide structure.

4. The bezel sealant as claimed in claim 3, wherein the curing agent is at least one selected from the group consisting of a multi-amine curing agent and an anhydride-type curing agent.

5. The bezel sealant as claimed in claim 4, wherein the filler is selected from the following inorganic fillers: silicon dioxide, aluminum oxide, zinc oxide, titanium oxide, magnesium oxide, calcium sulfate, aluminum nitride, and silicon nitride.

6. The bezel sealant as claimed in claim 5, wherein the silane coupling agent is at least one selected from the following materials:

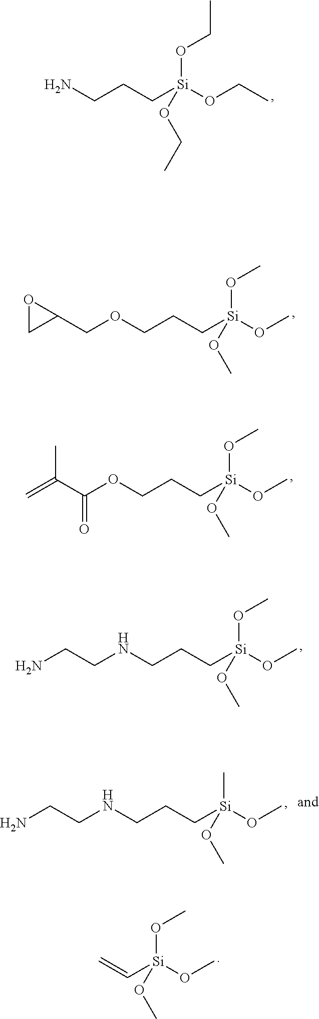

7. A polymer stabilized vertical alignment liquid crystal display panel, comprising a first substrate, a second substrate, a liquid crystal layer disposed between the first substrate and the second substrate, and a bezel sealant for sealing liquid crystal molecules between the two substrates, wherein the liquid crystal layer comprises at least polymerizable monomers, and a molecular weight of the polymerizable monomer is smaller than 500, the bezel sealant comprises at least the following compositions:
epoxy resin 20-60% by weight;
curing agent 5-50% by weight;
methacrylate resin or acrylate resin 20-60% by weight;
photoinitiator 0.1-1% by weight filler 5-35% by weight; and
silane coupling agent 0.05-5% by weight;
wherein the molecular weight of the methacrylate resin or the acrylate resin is greater than or equal to 500.

8. The liquid crystal display panel as claimed in claim 7, wherein the epoxy resin comprises an aromatic epoxy resin or/and a non-aromatic epoxy resin.

9. The liquid crystal display panel as claimed in claim 7, wherein the epoxy resin comprises a bisphenol-A epoxy resin, a bisphenol-F epoxy resin, a bisphenol-S epoxy resin, a novolac-type epoxy resin, a biphenyl epoxy resin, an epoxy resin having a cyclohexene oxide structure, and an epoxy resin having a cyclopentene oxide structure.

10. The liquid crystal display panel as claimed in claim 9, wherein the curing agent is at least one selected from the group consisting of a multi-amine curing agent and an anhydride-type curing agent.

11. The liquid crystal display panel as claimed in claim 10, wherein the filler is selected from the following inorganic fillers: silicon dioxide, aluminum oxide, zinc oxide, titanium oxide, magnesium oxide, calcium sulfate, aluminum nitride, and silicon nitride.

12. The liquid crystal display panel as claimed in claim 10, wherein the silane coupling agent is at least one selected from the following materials:

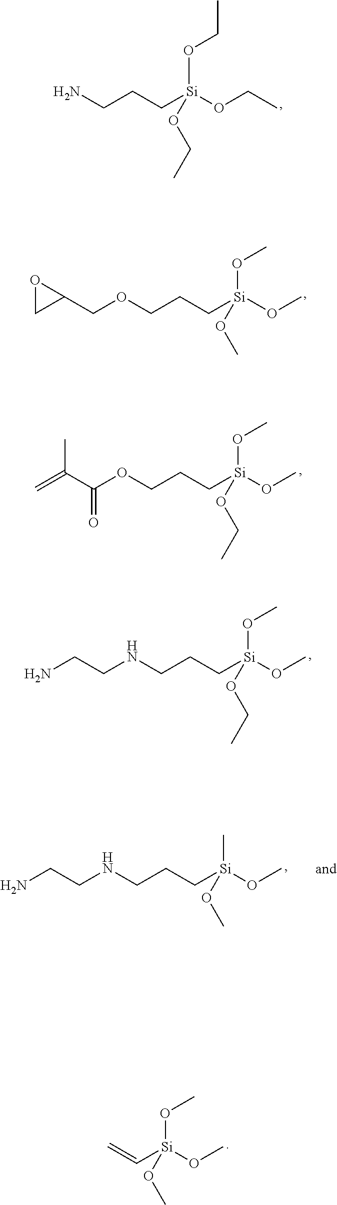

13. A polymer stabilized vertical alignment liquid crystal display comprising a liquid crystal display panel, the liquid crystal display panel comprising a first substrate, a second substrate, a liquid crystal layer disposed between the first substrate and the second substrate, and a bezel sealant for sealing liquid crystal molecules between the two substrates, wherein the liquid crystal layer comprises at least polymerizable monomers, and a molecular weight of the polymerizable monomer is smaller than 500, the bezel sealant comprises at least the following compositions:
epoxy resin 20-60% by weight;
curing agent 5-50% by weight;
methacrylate resin or acrylate resin 20-60% by weight;
photoinitiator 0.1-1% by weight filler 5-35% by weight; and
silane coupling agent 0.05-5% by weight;
wherein the molecular weight of the methacrylate resin or the acrylate resin is greater than or equal to 500.

14. The liquid crystal display as claimed in claim 13, wherein the epoxy resin comprises an aromatic epoxy resin or/and a non-aromatic epoxy resin.

15. The liquid crystal display as claimed in claim 13, wherein the epoxy resin comprises a bisphenol-A epoxy resin, a bisphenol-F epoxy resin, a bisphenol-S epoxy resin, a novolac-type epoxy resin, a biphenyl epoxy resin, an epoxy resin having a cyclohexene oxide structure, and an epoxy resin having a cyclopentene oxide structure.

16. The liquid crystal display as claimed in claim 15, wherein the curing agent is at least one selected from the group consisting of a multi-amine curing agent and an anhydride-type curing agent.

17. The liquid crystal display as claimed in claim 16, wherein the filler is selected from the following inorganic fillers: silicon dioxide, aluminum oxide, zinc oxide, titanium oxide, magnesium oxide, calcium sulfate, aluminum nitride, and silicon nitride.

18. The liquid crystal display as claimed in claim 17, wherein the silane coupling agent is at least one selected from the following materials: [chemical structure]
